(19) United States
(12) Patent Application Publication
(10) Pub. No.: US 2025/0135987 A1
(43) Pub. Date: May 1, 2025

(54) ADJUSTABLE VEHICLE LAMP ASSEMBLY AND VEHICLE LAMP ASSEMBLY ADJUSTMENT METHOD

(71) Applicant: Ford Global Technologies, LLC, Dearborn, MI (US)

(72) Inventors: Nicholas C. Sharpe, Grand Rapids, MI (US); Michael Robertson, JR., West Bloomfield, MI (US)

(21) Appl. No.: 18/497,287

(22) Filed: Oct. 30, 2023

(51) Int. Cl. B60Q 1/072; F21S 41/657

(52) U.S. Cl. CPC B60Q 1/072; F21S 41/657; B60Q 2200/36

(57) ABSTRACT

A vehicle lamp assembly includes a first light; a second light; and a belt that couples the second light to the first light such that adjustments to a position of the first light adjust a position of the second light. A vehicle lamp adjustment method includes pivotably coupling a first light of a lamp together with a second light of the lamp using a belt; and pivoting the first light to pivot the second light.

### TECHNICAL FIELD

This disclosure relates to an adjustable vehicle lamp assembly, such as a headlamp, and to a method of adjusting a vehicle lamp assembly.

### BACKGROUND

Vehicles can include various lamp assemblies, such as headlamps and taillamps. Some lamp assemblies include more than one light. For example, many headlamps include both a high-beam light that can emit a beam of light with a long-range focus and a low-beam light that can emit a beam of light with a short-range focus. From time to time, it may be necessary to adjust a position of one or more lights within a lamp assemblies.

### SUMMARY

In some aspects, the techniques described herein relate to a vehicle lamp assembly, including: a first light; a second light; and a belt that couples the second light to the first light such that adjustments to a position of the first light adjust a position of the second light.

In some aspects, the techniques described herein relate to a vehicle lamp assembly, wherein the belt is a toothed belt.

In some aspects, the techniques described herein relate to a vehicle lamp assembly, further including an actuator configured to adjust a position of the first light.

In some aspects, the techniques described herein relate to a vehicle lamp assembly, further including a lamp housing having an interior, the first light and the second light disposed within the interior.

In some aspects, the techniques described herein relate to a vehicle lamp assembly, wherein the first light is pivotably coupled to the lamp housing and configured to pivot about a first axis relative to the lamp housing, wherein the second light is pivotably coupled to the lamp housing and configured to pivot about a different, second axis relative to the lamp housing.

In some aspects, the techniques described herein relate to a vehicle lamp assembly, further including an actuator that is configured to adjust the position of the first light by pivoting the first light about the first axis.

In some aspects, the techniques described herein relate to a vehicle lamp assembly, wherein the first light and the second light are each pivotably coupled to the lamp housing at two positions.

In some aspects, the techniques described herein relate to a vehicle lamp assembly, wherein inboard and outboard sides of the first light and the second light are pivotably coupled to the lamp housing.

In some aspects, the techniques described herein relate to a vehicle lamp assembly, wherein the first light is vertically above the second light.

In some aspects, the techniques described herein relate to a vehicle lamp assembly, wherein the first light is a high-beam light, wherein the second light is a low-beam light.

In some aspects, the techniques described herein relate to a vehicle lamp assembly, wherein the high-beam light is vertically above the low-beam light.

In some aspects, the techniques described herein relate to a vehicle lamp assembly, wherein the first light, the second light, and the belt are constituents of a headlamp.

In some aspects, the techniques described herein relate to a vehicle lamp adjustment method, including: pivotably coupling a first light of a lamp together with a second light of the lamp using a belt; and pivoting the first light to pivot the second light.

In some aspects, the techniques described herein relate to a vehicle lamp adjustment method, wherein the first light and the second light pivot relative to a lamp housing.

In some aspects, the techniques described herein relate to a vehicle lamp adjustment method, wherein the first light and the second light are each pivotably coupled to the lamp housing at two positions.

In some aspects, the techniques described herein relate to a vehicle lamp adjustment method, wherein inboard and outboard sides of the first light and the second light are pivotably coupled to the lamp housing.

In some aspects, the techniques described herein relate to a vehicle lamp adjustment method, wherein the first light is vertically above the second light.

In some aspects, the techniques described herein relate to a vehicle lamp adjustment method, wherein the first light is a high-beam light, wherein the second light is a low-beam light.

In some aspects, the techniques described herein relate to a vehicle lamp adjustment method, further including pivoting the first light with an actuator.

In some aspects, the techniques described herein relate to a vehicle lamp adjustment method, wherein the lamp is a headlamp of a vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 shows a front view of an example vehicle having a plurality of lamp assemblies.

FIG. 2 shows a schematic perspective view of a headlamp from the vehicle of FIG. 1.

FIG. 3 illustrates a side view of a pully and a portion of a belt from the lamp assembly of FIG. 2.

FIG. 4 illustrates a closeup perspective view of an area of the lamp assembly in FIG. 2.

FIG. 5 shows a rear view of an area of the lamp assembly of FIG. 2.

FIG. 6 shows a section view take at line 6-6 in FIG. 5.

FIGS. 7A-7C show schematic side views of the first light 22 and the second light 26 tilted to different positions.

FIG. 8 shows a lamp assembly according to another exemplary aspect of the present disclosure.

FIG. 9 shows a front view of a variation of the lamp assembly of FIG. 2 according to yet another exemplary aspect of the present disclosure.

### DETAILED DESCRIPTION

This disclosure details exemplary adjustable lamp assemblies for a vehicle, and methods for adjusting those lamp assemblies.

Notably, the lamp assemblies can include more than one light, such as a high-beam light and a low-beam light. The lights can be pivotably coupled together such that aim of the lights can be adjusted together. The adjustments can be made when assembling the vehicle, or by a user that is operating the vehicle.

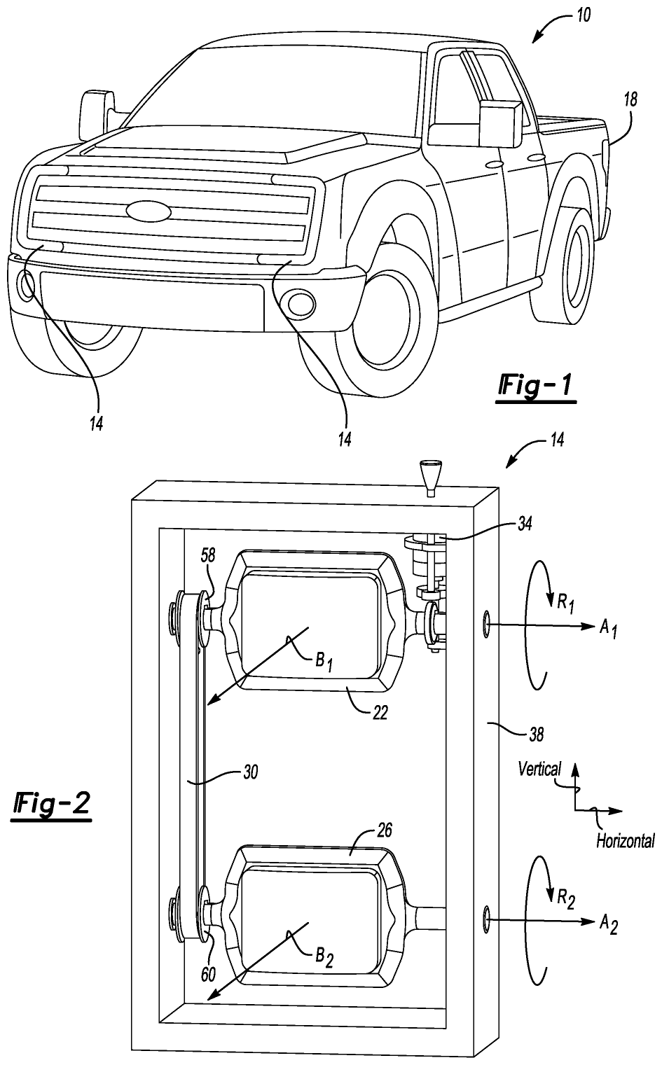

With reference to FIG. 1, an example vehicle 10 includes various lamp assemblies configured to emit light. The lamp assemblies include headlamps 14 and taillamps 18 in this example. The headlamps 14 can emit light forward from the vehicle 10.

With reference now to FIG. 2, a schematic view of a headlamp 14 on a driver's side of the vehicle 10 of FIG. 1 includes a first light 22, a second light 26, a belt 30, and actuator 34, and a lamp housing 38. A lens (not shown) can attach to the lamp housing 38 to enclose the first light 22, the second light 26, and the belt 30 within an interior of the headlamp 14.

The first light 22 is vertically above the second light 26 in this example. However, the positioning could be changed such that the second light 26 is vertically above the first light 22, or even horizontally aligned with the first light 22. Vertical and horizontal for purposes of this disclosure are with reference to ground or horizon and an ordinary orientation of the headlamp 14 when installed within the vehicle 10.

In this example, the first light 22 is a high-beam light of the headlamp 14. The first light 22 is pivotably coupled to the lamp housing 38 and configured to pivot about a first axis A₁ relative to the lamp housing 38. The first axis A₁ is a horizontal axis in this example.

The first light 22 is pivotably coupled to the lamp housing 38 at two positions-one on an inboard side of the first light 22 and one on an outboard side of the first light 22. Pivoting the first light 22 about the axis A₁ can tilt a beam of light B₁ emitted from the first light 22 vertically upward or vertically downward.

In this example, the second light 26 is a low-beam light of the headlamp 14. The second light 26 is pivotably coupled to the lamp housing 38 and is configured to pivot about a second axis A₂ relative to the lamp housing 38. The second axis A₂ is perpendicular to the first axis A₁. The second axis A₂ is thus also a horizontal axis.

The second light 26 is pivotably coupled to the lamp housing 38 at two positions-one on an inboard side of the second light 26 and one on an outboard side of the second light 26. Pivoting the second light 26 about the second axis A₂ can tilt a beam of light B₂ emitted from the first light 22 upward or downward.

The belt 30 pivotably couples the second light 26 to the first light 22. Notably, the first light 22 and the second light 26 are connected to each other only through the belt 30 and the lamp housing 38.

Adjustments to the position of the first light 22 drives the belt 30 to cause adjustments to the position of the second light 26. For example, rotating the first light in a direction R1 about the axis A₁ drives the belt 30 to rotate the second light 26 about the second axis A₂ in the direction R2.

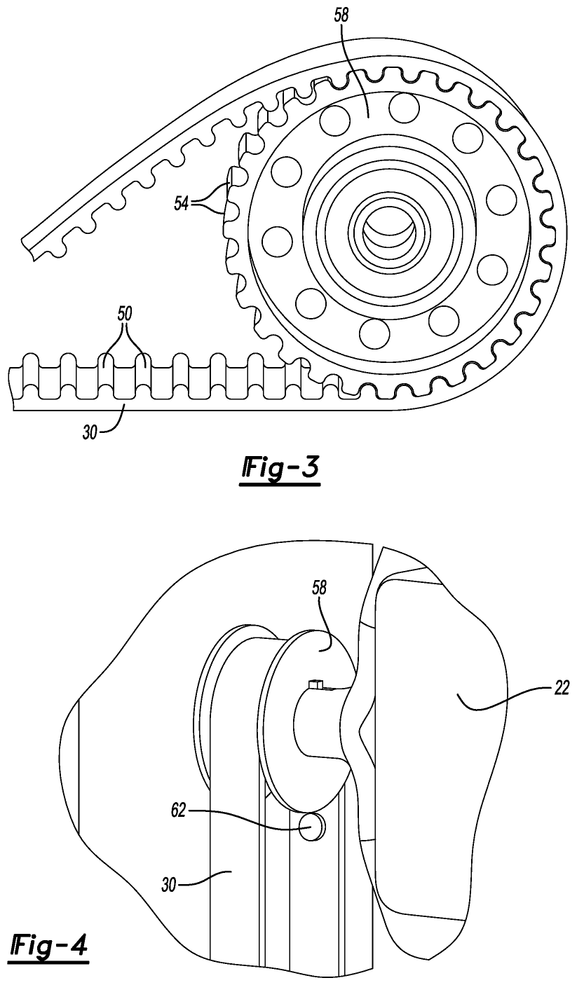

With reference now to FIGS. 3 and 4, and continuing reference to FIG. 2 the belt 30 can be a toothed belt having a plurality of teeth 50 that mesh with corresponding teeth 54 on a pulley 58. The belt 30 loops around the pully 58, which is directly connected to the first light 22. The belt 30 also loops around a pully 60 that is directly connected to the second light 26. Meshing the belt 30 with the pullies 58 and 60 can help to prevent the belt 30 from slipping relative to the pullies 58 and 60. The belt 30 can be reinforced with nylon to, among other things, mitigate stretching over time.

The belt 30 can be equipped with a blocking feature 62 that, after rotating the first light 22 about the first axis A₁ more than a threshold amount, blocks further rotation of the first light 22 about the axis A₁ by blocking movement of the belt 30 about the pulley 58. The blocking feature 62 could instead or additionally be incorporated into the pulley 58 of the first light 22.

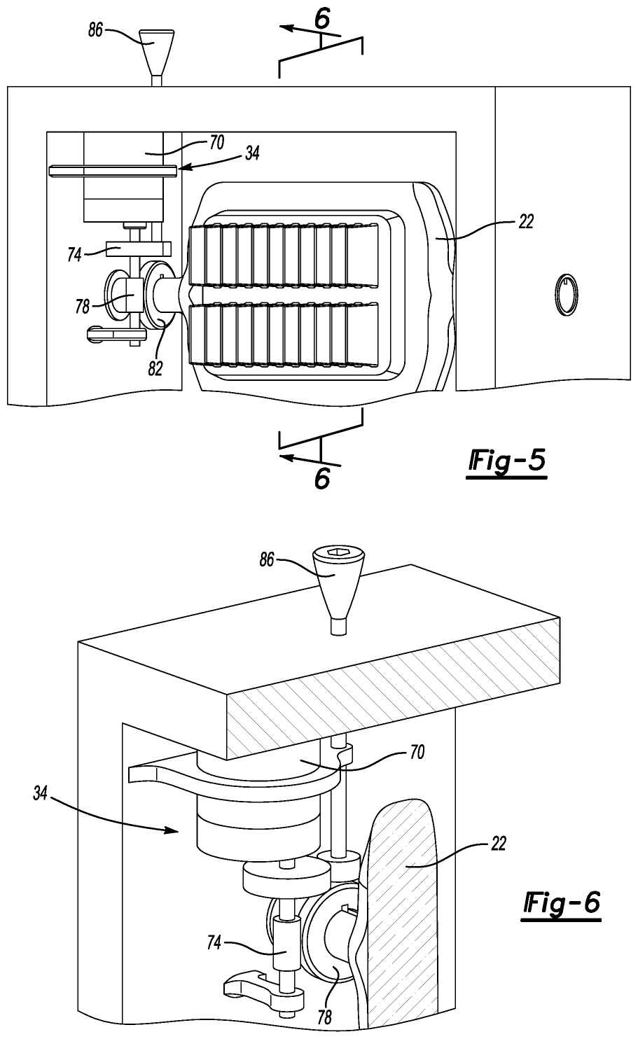

With reference now to FIGS. 5 and 6 and continued reference to FIGS. 2-4, the example actuator 34 can be a powered actuator that includes a motor 70. Powering the motor 70 rotates a shaft 74 of the actuator 34 to rotate a worm gear 78. A gear 82 disposed about the axis A₁ meshes with the worm gear 78. Turning the shaft 74 thus tilts the first light 22.

The shaft 74 could also be manually rotated utilizing a manual adjustment device 86. The manual adjustment device 86 can be, for example, turned by an worker at an assembly plant to initially adjust a tilt of the first light 22 and the second light 26.

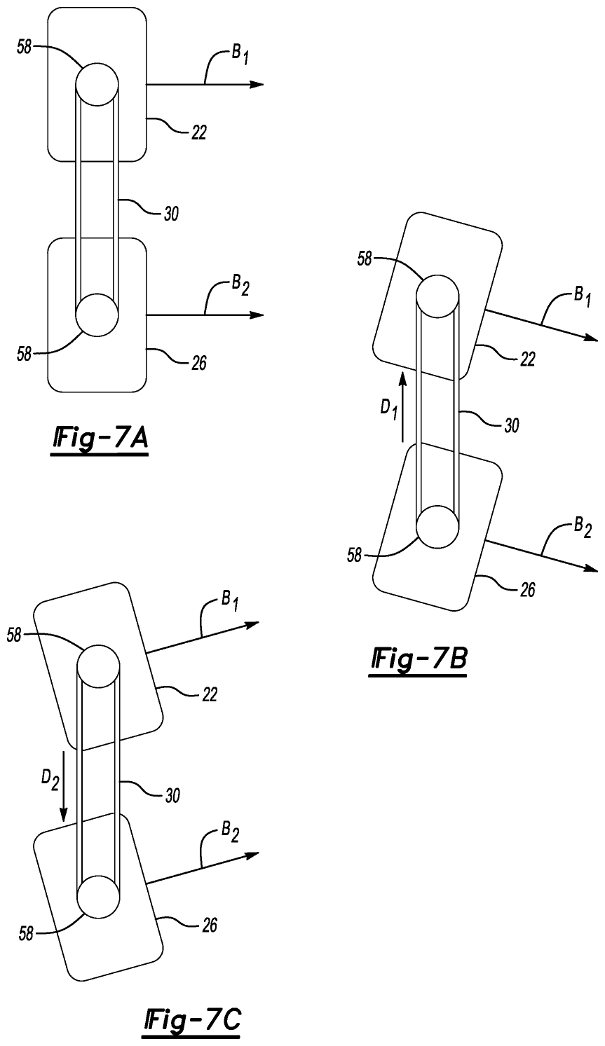

With reference to the schematic side views of FIGS. 7A-7C, from a position shown in FIG. 7A where the first light 22 and the second light 26 emit light horizontally forward, the first light 22 can be tilted downward as shown in FIG. 7B. This drives the belt 30 in the direction D₁ causing the second light 26 to tilt downward with the first light 22. Tilting the first light 22 upward drives the belt 30 in a direction D₂, which causes the second light 26 to tilt upward as shown in FIG. 7C.

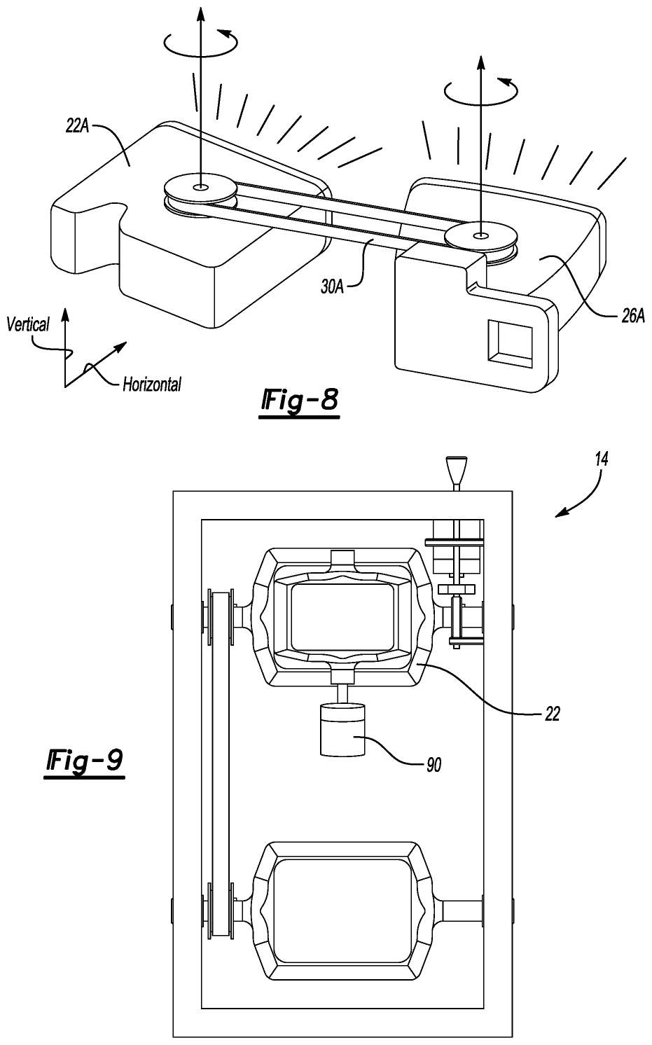

As shown in FIG. 8, in another exemplary embodiment, a first light 22A could be pivotably coupled to a second light 26A through a belt 30A. The first light 22A and the second light 26A are vertically aligned.

The tilting of the first light 22A could be tilting about a vertically extending axis. The tilting of the first light 22A could drive the belt 30A to cause a corresponding tilting of the second light 26A about a vertically extending axis.

In a variation shown in FIG. 9, the first light 22 could be equipped with a leveling device 90 that helps to maintain a tilt of the first light 22 in a position that directs light horizontally from the headlamp 14. The leveling device 90 could be a self-leveling device similar to a gyroscope. Although shown in connection with the first light 22, the leveling device 90 could instead or additionally be incorporated into the second light 26.

The adjusting of a headlamp can occur during vehicle production. For example, an assembler can interface with a headlamp adjuster to adjust light from the headlamp. Regulations can require that an end user, e.g., customer, is blocked from access to the headlamp adjuster. Some assemblies and methods of this disclosure can help to block access to the headlamp adjuster and to confirm that such access has been blocked.

The foregoing description shall be interpreted as illustrative and not in any limiting sense. An assembler of ordinary skill in the art would understand that certain modifications could come within the scope of this disclosure. For these reasons, the following claims should be studied to determine the true scope and content of this disclosure.

1. A vehicle lamp assembly, comprising:
a first light;
a second light;
a belt that pivotably couples the second light to the first light such that pivoting the first light pivots the second light; and
an actuator configured to pivot the first light.

2. The vehicle lamp assembly of claim 1, wherein the belt is a toothed belt.

3. (canceled)

4. The vehicle lamp assembly of claim 1, further comprising a lamp housing having an interior, the first light and the second light disposed within the interior.

5. The vehicle lamp assembly of claim 4, wherein the first light is pivotably coupled to the lamp housing and configured to pivot about a first axis relative to the lamp housing, wherein the second light is pivotably coupled to the lamp housing and configured to pivot about a different, second axis relative to the lamp housing.

6. The vehicle lamp assembly of claim 5, further comprising an actuator that is configured to adjust the position of the first light by pivoting the first light about the first axis, the actuator interfacing with the first light on a first axial side of the first light, the belt interfacing with first light on an opposite, second axial side.

7. The vehicle lamp assembly of claim 5, wherein the first light and the second light are each pivotably coupled to the lamp housing at two positions.

8. The vehicle lamp assembly of claim 5, wherein inboard and outboard sides of the first light and the second light are pivotably coupled to the lamp housing.

9. The vehicle lamp assembly of claim 1, wherein the first light is vertically above the second light.

10. The vehicle lamp assembly of claim 1, wherein the first light is a high-beam light, wherein the second light is a low-beam light.

11. The vehicle lamp assembly of claim 10, wherein the high-beam light is vertically above the low-beam light.

12. The vehicle lamp assembly of claim 1, wherein the first light, the second light, and the belt are constituents of a headlamp.

13. A vehicle lamp adjustment method, comprising:
pivotably coupling a first light of a lamp together with a second light of the lamp using a belt; and
pivoting the first light to pivot the second light.

14. The vehicle lamp adjustment method of claim 13, wherein the first light and the second light pivot relative to a lamp housing.

15. The vehicle lamp adjustment method of claim 14, wherein the first light and the second light are each pivotably coupled to the lamp housing at two positions.

16. The vehicle lamp adjustment method of claim 14, wherein inboard and outboard sides of the first light and the second light are pivotably coupled to the lamp housing.

17. The vehicle lamp adjustment method of claim 13, wherein the first light is vertically above the second light.

18. The vehicle lamp adjustment method of claim 13, wherein the first light is a high-beam light, wherein the second light is a low-beam light.

19. The vehicle lamp adjustment method of claim 13, further comprising pivoting the first light with an actuator, the actuator configured to drive the belt through the first light.

20. The vehicle lamp adjustment method of claim 13, wherein the lamp is a headlamp of a vehicle.

21. A vehicle lamp assembly, comprising:
a first light;
a second light;
a belt that couples the second light to the first light; and
an actuator that adjusts a position of the first light to drive the belt and adjust a position of the second light, the actuator driving the belt through the first light.
